(19) United States
(12) Patent Application Publication
(10) Pub. No.: US 2022/0280950 A1
(43) Pub. Date: Sep. 8, 2022

(54) METHOD AND DEVICE FOR MILLING AND SEPARATION OF SOLIDS AND GRANULAR MATERIALS INCLUDING METAL CONTAINING MATERIALS AS WELL AS PHYTOGENIC MATERIALS WITH HIGH LEVEL OF SILICON IN A CONTROLLED AIRFLOW

(71) Applicants: Kostiantyn Vashkovskyi, Fort Myers, FL (US); Andrii Seleznov, Krivoy Rog (UA)

(72) Inventors: Kostiantyn Vashkovskyi, Fort Myers, FL (US); Andrii Seleznov, Krivoy Rog (UA)

(21) Appl. No.: 17/752,864

(22) Filed: May 25, 2022

Related U.S. Application Data
(62) Division of application No. 15/813,093, filed on Nov. 14, 2017, now Pat. No. 11,369,973.

(51) Int. Cl. B02C 23/30; B02C 13/286; B02C 13/288; B02C 23/32; B02C 13/28; B02C 13/18

(52) U.S. Cl. CPC B02C 23/30; B02C 13/286; B02C 13/288; B02C 23/32; B02C 13/2804; B02C 13/18; B02C 2013/28609

(57) ABSTRACT

The invention relates to the method for milling and separation into fractions of solids and granular materials in a controlled airflow. The device for milling and separation of solids and granular materials consists of a round milling chamber with a system of pneumatic separation comprising of a vertical cylindrical body that has an uploading slot for solids and granular materials and unloading channels for the milled products of light, medium and coarse fractions. A rotating disc and a conical divider are located inside a vertical cylindrical body. The rotating disc has plates (hammers) and removable blades of different sizes and configurations. System of pneumatic separation consists of a milling chamber, an air slugcatcher, channels for the milled material, and a chamber of higher pressure. Such construction of the device allows to obtain products of a highest quality, and to improve the separation by dividing the material into three fractions: light, medium and coarse.

### PRIORITY CLAIM

This application claims the benefit to and is a divisional of U.S. patent Application No. 15/813,093, filed on Nov. 14, 2017, and entitled “Method and Device for Milling and Separation of Solids and Granular Materials Including Metal Containing Materials As Well As Phytogenic Materials With High Level of Silicon In a Controlled Airflow” which application is incorporated herein by reference.

### BACKGROUND OF THE INVENTION

The invention relates to the field of processing of solids and granular materials in metallurgy and other industries where milling of materials and its separation are required (including metal containing materials, as well as phytogenic materials with a high level of silicon). Rotaries of centrifugal percussive mills are known where a milling chamber consists of a vertical cylindrical body with an unloading axial channel for a metal-containing material and unloading channels for the milled material, inside of which a rotating disc is installed on the vertical shaft. The disc has blades radially installed on its upper surface with the sides welded with carbide-tipped elements.

Also, centrifugal percussive mills are known where a milling chamber consists of a vertical cylindrical body with an uploading axial channel for metal containing material and unloading channels for the milled material of light and heavy fractions, inside of which a rotating disc is installed on the vertical shaft. The disc has blades radially installed on its upper surface with the sides welded with carbide-tipped elements. There is a divider installed inside the body of such milling chamber. Common disadvantages of these mills are their low reliability and small productivity caused by possible clinches and breakdowns when a piece of material exceeding the gap between the wall of the chamber and the rotating disc falls in that gap. Also, when the humidity of the material exceeds 5%, then the operative sections of the rotating disc and a working chamber are cemented with the material being milled until a self-clinching and rotor's misbalance occur. Such mills do not separate the material into fractions at all.

The use of the present device improves the quality of milling by obtaining the finest fraction of the product being milled and by excluding the self-sealing of the material being milled to the operative parts of the device. It improves the quality of separation of the material by dividing the obtained product into three fractions (light, medium and coarse). It also mills any hard material including phytogenic material containing a high level of silicon. And, it increases the reliability and durability of the device. Same time, it reduces the maintenance and the repair time of the device.

### SUMMARY OF THE INVENTION

It is therefore the task of this invention to improve the already existing devices for milling solids and granular materials including metal containing materials, as well as phytogenic materials with a high level of silicon, by changing the structure of the device elements; to eliminate the process of self-sealing of the material being milled; to achieve more efficient separation of the product in a milling chamber and in an air slugcatcher; to minimize the wear of the anti-abrasive pads installed on the edge of the rotating disc (rotary) and the peripheral part of the chamber of higher pressure by increasing the air flow by enlarging the length and the width of the removable blades installed in the lower part of the rotating disc (rotary). That will improve to the device reliability and durability, and will increase the productivity of the device.

This task is solved in accordance with the invention by the method and the device described below. Preferred embodiments of the invention and the equipment of the invention form the subject of the claims.

According to the invention, the device for milling and separation of solids and granular materials including metal containing materials, as well as phytogenic materials with a high level of silicon, in a controlled airflow consists of a milling chamber with a system of pneumatic separation. The device comprises of a vertical cylindrical body with the uploading axial slot for the original material and unloading channels and units for the milled material of light, medium and coarse fractions. A rotating disc (rotary) is installed on the bearing unit inside the mentioned cylindrical body, with plates (hammers) radially installed on the upper surface of the rotary. Sides of plates are welded with carbide-tipped electrodes. Also, a conical divider is installed inside the cylindrical body which lower working edge also welded along the periphery. Removable blades located in the lower part of the rotating disc (rotary) are enlarged to create more air pressure between the anti-abrasive pads, thereby preventing the bigger particles of the material from getting into the gap between the rotary and the cylindrical body of the device. The upper surface of the rotating disc (rotary) has a circular ledge installed along its periphery against which the removable plates (hammers) abut. The inner surface of the circular ledge is interfaced with the surface of the rotating disc along the inclined plane in sections between the plates (hammers). The system of pneumatic separation consists of a milling chamber coupled with an air slugcatcher, upper and lower channels for the milled material of a light fraction, a vertical tubular channel connected to the unloading channel for the milled material of the medium fraction and the upper part of the unloading channel for the milled material of the medium fraction. The unloading channel is in the circumferential part of the upper end wall of the milling chamber's body. The system of pneumatic separation also includes a chamber of higher pressure created in the gap between the rotating disc and the lower end wall of the body of the mentioned milling chamber with a slot. The air intake is fulfilled through the controlled air flow control valve. Removable plates (hammers) have different lengths and configurations. Their sides are welded with carbide-tipped electrodes, and can be changed depending on the material being processed. The angle of inclination of the conical divider is no less than 45 degrees, and the unloading channel for the milled material of the coarse fraction is built in the circumferential part of the lower end wall of the body of a milling chamber. The circular ledge of the rotating disc (rotary) is built on the same level as the blades, or higher. Maximum dimensions of the plates are set experimentally considering the active zone of destruction of the original material. An optimal working gap between the inner surface of the milling chamber body and the plates (hammers) is provided when a diameter of the base of the conical divider is no more than ⅔ part of the diameter of the rotating disc. The most efficient circulation of the material being milled in the milling chamber is ensured when the angle of inclination of the conical divider is no less than 45 degrees. During that process, sticking of the material to the working parts and self-sealing of the material being milled to the operative parts are not observed. Installation of the circular ledge along the circumference of the rotating disc (rotary) into which the plates (hammers) abut, and which inner surface is interfaced with the surface of the rotating disc (rotary) along the inclined plane in the sections between the plates (hammers), provides, in the process of milling the original material, for a return of underprocessed material into the milling chamber by cyclically blowing the material being milled, where the underprocessed material of the coarse fraction is blown by an inclined plane and a circular ledge toward the surface of the conical divider. As a result, the material being milled is supplied to the active zone of the milling chamber and it is separated as milled. This provides for an optimal mode of the cyclic milling of the original material and its separation. Installation of the plates (hammers) on the same level as the circular ledge provides for an optimal mode of milling of the original material where sticking of the material to the working parts and self-sealing of the material being milled to the operative zone are not observed. Plates (hammers) of various lengths and configurations are used in the system that was established experimentally, depending on the material being processed. This allows to mill the hardest materials including phytogenic materials with a high level of silicon. It greatly improves the quality of the finished product.

Anti-abrasive pads are made from a high resistance alloyed steel that protects the rotating disc (rotary) and the body of the milling chamber. The installed air supply control valve improves the separation of the light fraction and prolongs the expiration of the anti-abrasive pads increasing the productivity of the device.

The upper part of the device is equipped with four new supporting stands one of which is removable. Three stands mounted tight to the body of the milling chamber but the fourth stand can be removed quickly. New location of the support system allows to quickly separate the chamber of higher pressure and the rotating disc from the body of the device that reduces the maintenance and the repair time of the device.

The electric motor of the device is installed remotely and connected to the driven pulley by a belt drive. Pulleys are mounted cantilever. The support system is made of a part of the stocking of the truck bridge, the hub and the semi-axle, which greatly simplifies the support system and reduces the expenses, increases the durability, reduces the load on the bearing unit, increases the service life of the unit.

### BRIEF DESCRIPTION OF THE DRAWINGS

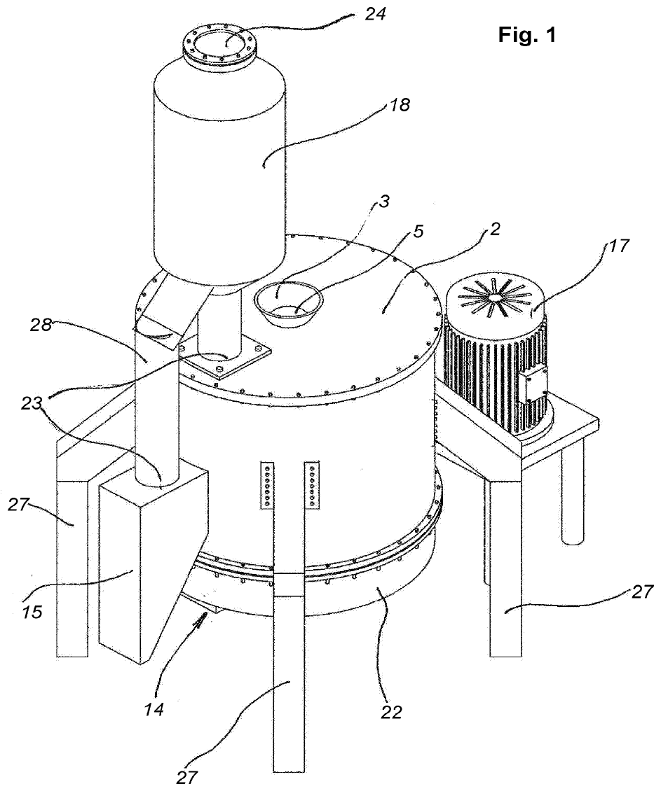

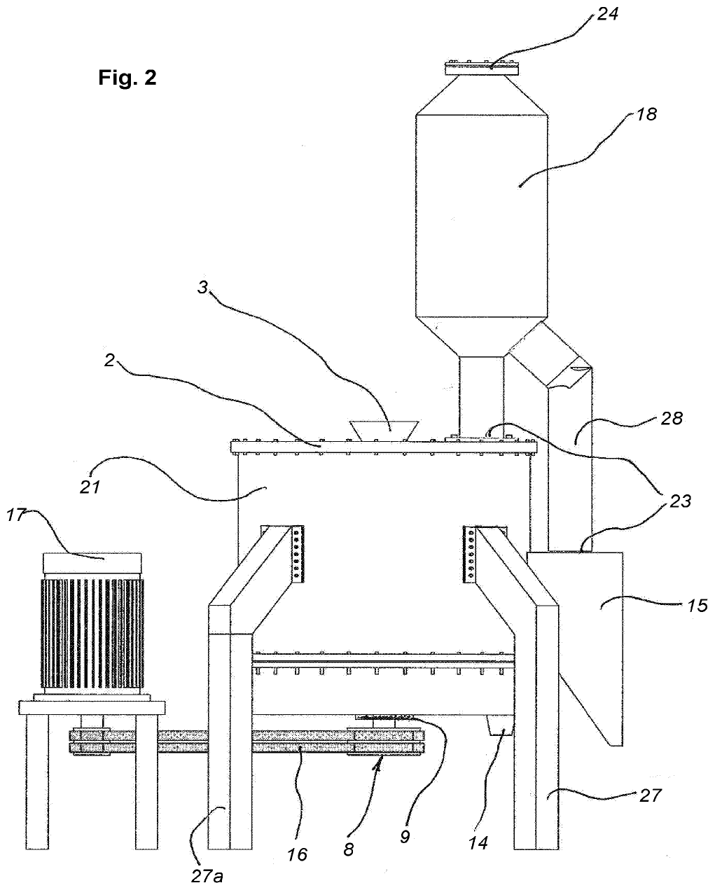

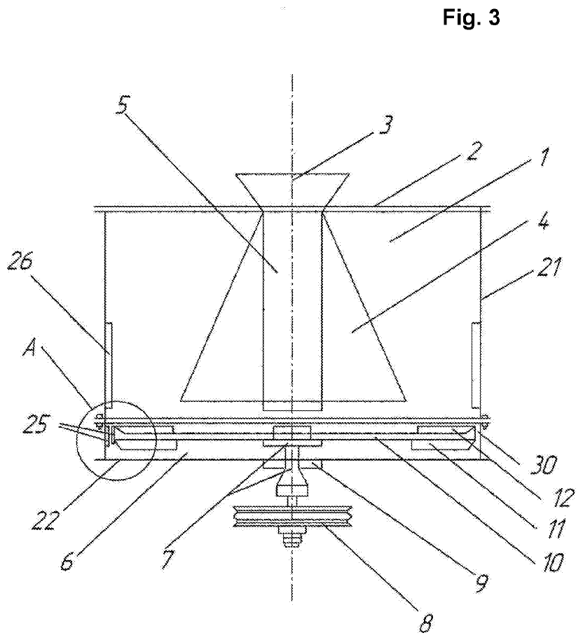

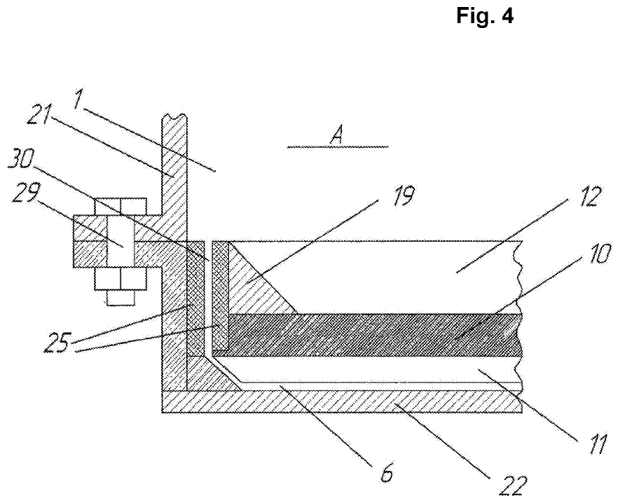

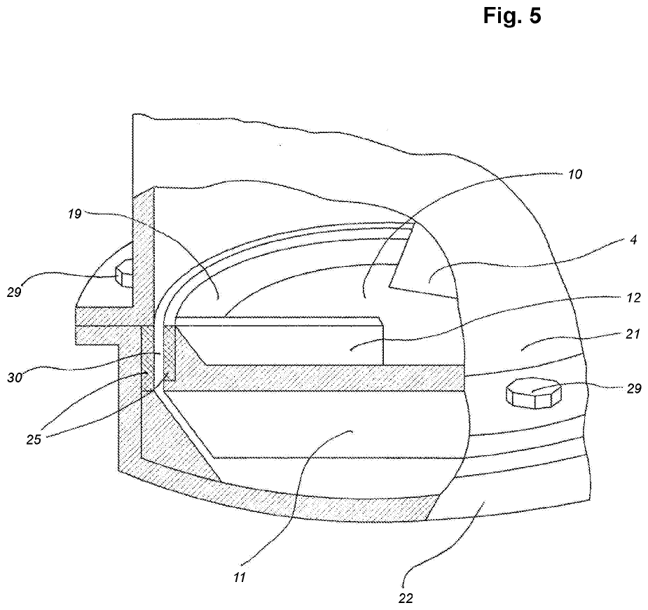

Now, the invention will be described in more detail below with reference to the following drawings, whereby: FIG.1 — shows a perspective view of the device for milling and separation of solids and granular materials including metal containing materials as well as phytogenic materials with a high level of silicon in a controlled airflow; FIG. 2 — side view of the device in accordance with FIG. 1; FIG. 3 — shows a cross sectional view of the body of the device for milling and separation of solids and granular materials including metal containing materials, as well as phytogenic materials with a high level of silicon according to FIG.1 and FIG. 2; FIG. 4 — shows a cross sectional view of a section A of a lower part of the body of the device according to FIG. 3; FIG. 5 — shows a cross sectional view of a part of the rotating disc (rotary) of FIG.1;

### DETAILED DESCRIPTION OF THE INVENTION

Many specific details of certain embodiments of the invention are set forth in the following description and in FIGS. 1 through 5 to provide a thorough understanding of such embodiments. FIG. 1 shows a perspective view, FIG. 2 shows a side view and FIG. 3 shows a cross sectional view of the device for milling and separation of solids and granular materials including metal containing materials, as well as phytogenic materials with a high level of silicon in a controlled air flow. The device comprises of a round milling chamber 1 (see FIG. 3) with a system of pneumatic separation consisting of a vertical cylindrical body 21 that has an uploading slot 3 and uploading channel 5 for the original material and unloading channels for the milled materials of light 23, medium 15 and coarse 14 fractions. A driven pulley 8 of the belt drive 16 is installed on a bearing unit 7 in the lower part of the milling chamber 1. A rotating disc (rotary) 10 is installed on a bearing unit 7 in the upper part of the milling chamber 1. Removable plates (hammers) 12 of different lengths and configurations are radially installed on the upper surface of the rotating disc (rotary) 10. The plates are welded with carbide-tipped electrodes. A conical divider 4 is installed in the upper part of the milling chamber. The rotating disc (rotary) 10 has removable blades 11 installed on its lower surface. A circle ledge 19 (see FIG. 5) is fulfilled on the upper surface of the rotating disc (rotary) 10 along its periphery. Removable plates (hammers) 12 abut to the circle ledge. The inner surface of the circle ledge 19 is interfaced, in sections between the plates (hammers) 12, with the surface of the rotating disc 10 along the inclined plane of the circle ledge 19.

The system of pneumatic separation consists of a milling chamber 1 coupled with an air slugcatcher 18, upper and lower channels 23 for the milled material of the light fraction, and a vertical tubular channel 28. The latter is connected to the unloading channel 15 for the milled material of the medium fraction. Also, a system of pneumatic separation has a chamber of higher pressure 6 (see FIG. 3 and FIG. 4) created in the gap between the rotating disc 10 and the lower end wall 22 of the body 21 of the milling chamber 1. The body of the mentioned chamber communicates with the atmosphere through an air supply control valve 9. Removable plates (hammers) 12 have different lengths and configurations and are selected depending on the material being processed. The sides of the plates (hammers) 12 are welded with carbide-tipped electrodes. The bottom diameter of a conical divider 4 is no more than ⅔ part of the diameter of the rotating disc (rotary) 10. The angle of inclination of the conical divider 4 is no less than 45 degrees. The unloading channel 14 for the milled material of the coarse fraction is installed in the peripheral part of the lower end wall 22 of the body 21 of a milling chamber 1. The circular ledge 19 of the rotating disc (rotary) 10 is fulfilled on the same level as the plates 12, or higher. An electric motor 17 is used to rotate the disc (rotary) through a belt drive 16 and a bearing unit 7.

The device for milling and separation of solids and granular materials including metal containing materials, as well as phytogenic materials with a high level of silicon, in a controlled air flow works as follows. Initially, the device for milling and separation of solids and granular materials including metal containing materials, as well as phytogenic materials with a high level of silicon, in a controlled air flow is set to the initial working position. For this purpose, the electric motor 17 of the rotating disc 10 is switched on, and then a milling chamber 1 is loaded with a dosed material through the uploading axial slot 3 and the uploading channel 5. The material is discarded to the peripheral part of the rotating disc (rotary) 10 by centrifugal force, where the plane of motion of the milled material changes from the horizontal to inclined plane within a range from 50 to 60 degrees. Wherein, the flight path of the material being milled is directed to the upper part of the milling chamber 1 that eliminates the process of self-sealing of the material being milled on its inner surface. The material being milled, having reached the upper end wall 2 of the body 21 of the milling chamber 1 is returned under the influence of gravity and due to the elastic features of particles to the operative area of the milling chamber 1 by rolling along the surface of the conical divider 4 onto the plates (hammers) 12 of the rotating disc (rotary) 10, while colliding with other particles of the material being milled. The particles of the material being milled in the milling chamber 1 perform a translational motion along the surface, as well as their own axial motion. Such complicated movement of the particles of the material being milled in the milling chamber 1 provides for the destruction of these particles giving them a spherical shape. In particular, metallic inclusions that are present in the original material acquire such form. The material milled to the pulverized or so-called light fraction, passes through the section of percussive loadings and reaches the unloading channel 23 for the milled material of the light fraction and then goes under the air pressure into the air slugcatcher 18 of the separation system. The air flow in the chamber of higher pressure 6, under the pressure of which the pulverized light fraction of the milled material goes into the air slugcatcher 18 of the pneumatic separation system through the unloading channel 23, is formed by the rotation of the removable blades 11 installed on the lower surface of the rotating disc (rotary) 10. Wherein, the air is sucked and pumped into the circular gap between the anti-abrasive pads 25 (see FIG. 4) through the controlled air supply valve 9. Since the mentioned circular gap communicates all the time with the chamber of higher pressure 6, the bigger particles of the material being milled return to the operative area of the milling chamber 1 under the pressure of the chamber 6 and the rotating disc (rotary) 10, with the plates (hammers) 12, as well as the inclined plane of the circular ledge 19 (see FIG. 4). When solid metal pieces that are smaller than the gap between the anti-abrasive pads 25 (see FIG. 4) fall into that gap, they go into the coarse fraction channel 14. Thereby, this eliminates the possibility of clinch of the rotating disc (rotary) 10 and possible breakdown of the device. As the material being milled consists of both solid and soft minerals it breaks down into very small (nonresistant and pulverized) and large (firm) particles under the influence of impact loadings. As a result, these particles are divided into three flows in the system of pneumatic separation: coarse particles unload through the lower channel 14, medium particles unload through the channel 15 and smaller pulverized particles unload by the air flow through the diversion channel 23 into the air slugcatcher 18 where the separation of the lighter material is made again and it unload through the channel 24. The part of the material that has bigger particles, when accumulated in the air slugcatcher 18, return to the chamber 1 where it is re-milled. The length and shape of the plates (hammers) are selected on the grounds of the active zone for the destruction of the original material under the influence of impact loadings. The bottom diameter of the conical divider is no more than ⅔ part of the diameter of the rotating disc (rotary) 10, proceeding from the calculation that the formed area does not overlap the working area of the moving plates (hammers) 12. The angle of inclination of the conical divider 4 is no less than 45 degrees that ensures the rolling of the undermilled particles along the sides of the conical divider into the working area of the milling chamber 1. The upper part of the device is equipped with four stands 27, one of which is removable 27a. Three stands are mounted tight to the body of the milling chamber 1 and one stand is quickly removable together with the chamber of higher pressure and the rotating disc (rotary) 10 for maintenance and repair works, thereby reducing the time that could be spent on dismounting and installation of the device.

What is claimed is:

1. A method, comprising:
cyclically destructing and balling a metal and solid spherical particles of a material, with its simultaneous separating into fractions under the density, in a controlled air flow inside the milling chamber of a rotary centrifugal percussive mill in a closed cycle.

2. The method of claim 1, further comprising: pumping the air into the milling chamber.

3. The method of claim 1, further comprising: supplying dosed material into the milling chamber through the uploading slot and uploading channel.

4. The method of claim 1, further comprising: moving of the material to the upper part of the milling chamber through the peripheral part of the rotating disc.

5. The method of claim 1, further comprising: returning of the material to the milling chamber, colliding with other particles in an air flow created by the rotary that leads to the particles destruction, milling, balling and acquiring a spherical shape.

6. The method of claim 1, further comprising: milling to the light fraction and extracting through the air slug catcher and an unloading channel under the air pressure.

7. The method of claim 1, further comprising: returning of the bigger pieces of the material to the milling chamber and a channel for a coarse fraction.

8. The method of claim 1, further comprising: dividing of the material to three fractions: light, medium and coarse.

9. The method of claim 1, further comprising: accumulating the material in an air slug catcher and returning to the milling chamber for remilling.

10. The method of claim 1, further comprising: controlling a frequency of the rotary movement, and the air flow pumped to a milling chamber and a chamber of higher pressure.

11. The method of claim 1, further comprising: obtaining a finished product from the channel for the coarse fraction, an enriched concentrate—from the channel for the medium fraction, and a finely dispersed pulverized product—from the air slugcatcher.
